(19) United States
(12) Patent Application Publication
(10) Pub. No.: US 2025/0024832 A1
(43) Pub. Date: Jan. 23, 2025

(54) IMMUNE-REDUCED CROSS-CIRCULATION CIRCUIT

(71) Applicant: VANDERBILT UNIVERSITY, Nashville, TN (US)

(72) Inventors: Wei K. Wu, Nashville, TN (US); Matthew Bacchetta, Nashville, TN (US); Sophoclis Alexopoulos, Nashville, TN (US); John W. Stokes, Nashville, TN (US); Rei Ukita, Nashville, TN (US); Yatrik J. Patel, Nashville, TN (US)

(21) Appl. No.: 18/684,418

(22) PCT Filed: Aug. 19, 2022
(86) PCT No.: PCT/US2022/040942

§ 371 Date: Feb. 16, 2024

Related U.S. Application Data
(60) Provisional application No. 63/235,392, filed on Aug. 20, 2021.

(51) Int. Cl. A01N 1/02

(52) U.S. Cl. CPC A01N 1/0247

(57) ABSTRACT

A system for maintaining immune separation between an extracorporeal organ and a bioreactor includes an organ chamber holding an extracorporeal organ and a cross-circulation circuit connecting the extracorporeal organ with the bioreactor. The cross-circulation circuit can direct the flow of perfusate therebetween. The bioreactor may include an allogeneic or xenogeneic host organism. for example a swine host. The cross-circulation circuit comprises at least one semipermeable membrane configured to establish an immunologic barrier to maintain separation between the immune responses of the bioreactor and the extracorporeal organ and to maintain physiologic stability of the bioreactor and the extracorporeal organ. The immune-reduced cross-circulation circuit may improve extracorporeal organ viability for research and transplant purposes.

### CROSS-REFERENCE TO RELATED APPLICATIONS

This application claims the benefit of U.S. Provisional Application No. 63/235,392, entitled “IMMUNE-REDUCED CROSS-CIRCULATION CIRCUIT,” filed 20 Aug. 2021. The entirety of this provisional application is hereby incorporated by reference for all purposes.

### TECHNICAL FIELD

The present disclosure relates generally to extracorporeal organ support and, more specifically, to reducing immunologic interfacing between an extracorporeal organ and a bioreactor with an immune-reduced cross-circulation circuit.

### BACKGROUND

Cirrhosis of the liver is associated with a large global health burden with the only curative treatment being liver transplantation. Cirrhosis patients often linger on the liver transplant waiting list, risking mortality, due to a scarcity of suitable donor organs. Suitable donor organ scarcity is also a problem for all patients waiting for a donor organ transplant, not just cirrhosis patients. In the event a donor organ becomes available, there are significant bottlenecks arising from insufficient organ salvage techniques.

### SUMMARY

More suitable donor organs would be available with better organ salvage techniques. One such better organ salvage technique includes an improved extracorporeal organ support mechanism that employs a bioreactor for comprehensive physiologic support while providing an immunologic barrier between the extracorporeal organ and the bioreactor with an immune-reduced cross-circulation circuit. Such an immune reduced cross-circulation circuit employs loops separated by interfaces that provide the immunological barrier, preventing certain damaging agents from crossing between the extracorporeal organ and the bioreactor.

In an aspect, the present disclosure can include a system for maintaining separation between immune responses of a bioreactor and an extracorporeal organ. The system comprises an organ chamber configured to hold the extracorporeal organ and a cross-circulation circuit configured to connect the extracorporeal organ and the bioreactor and direct the flow of perfusate therebetween. The cross-circulation circuit comprises at least one semipermeable membrane configured to establish an immunological barrier to maintain separation between immune responses of the bioreactor and immune responses of the extracorporeal organ and to maintain physiologic stability of the bioreactor and the extracorporeal organ.

In another aspect, the present disclosure can include a cross-circulation system for maintaining separation between immune responses of a bioreactor and an extracorporeal organ. The cross-circulation circuit comprises an H loop comprising the bioreactor, an O loop comprising an extracorporeal organ housed in an organ chamber, an immune separation loop, and at least one pump. The immune separation loop comprises a first interface with the H loop, which comprises a first semipermeable membrane, and a second interface with the O loop, which comprises a second semipermeable membrane. The first semipermeable membrane and the second semipermeable membrane are configured to maintain separation between immune responses of the H loop and the O loop. The at least one pump is configured to direct flow through at least one of the H loop, the O loop and the immune separation loop

In another aspect, the present disclosure can include a method for maintaining separation between immune responses of a bioreactor and an extracorporeal organ that includes the following steps. Establishing a cross-circulation circuit between the bioreactor and the extracorporeal organ in an organ chamber. The cross-circulation circuit comprises an H loop comprising the bioreactor, an O loop comprising the extracorporeal organ, an immune separation loop, and at least one pump configured to direct flow through at least one of the H loop, the O loop, and the immune separation loop. Directing a flow of perfusate between the bioreactor in the H loop and the extracorporeal organ in the O loop through the immune separation loop. The immune separation loop comprises a first interface with the H loop, which comprises a first semipermeable membrane, and a second interface with the O loop, which comprises a second semipermeable membrane. Maintaining viability of the extracorporeal organ using the first semipermeable membrane and the second semipermeable membrane, where the first and second semipermeable membranes are configured to maintain separation between immune response of the H loop and the O loop.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a box diagram of a perfusion system employing an immune-reduced cross-circulation circuit between an extracorporeal organ and a bioreactor;

FIGS. 2 and 3 are schematic diagrams of example cross-circulation circuits that can be used by the perfusion system of FIG. 1;

FIG. 4 is an illustration of an example use of the perfusion system of FIG. 1 as Veno-Venous immune-reduced cross-circulation circuit;

FIG. 5 is an illustration of an example use of the perfusion system of FIG. 1 as a Veno-Arterial Venous immune-reduced cross-circulation circuit;

FIG. 6 is a process flow diagram illustrating a method for establishing an immune-reduced cross-circulation circuit;

FIG. 7-13 are graphical representations of ions, molecules, and compounds that may flow through the semipermeable membrane(s) of the immune-reduced cross- circulation circuit.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “circuit” refers to a complete and closed path through which a liquid (such as blood, a man-made perfusate, etc.) can flow. One example of a circuit is a cross-circulation circuit.

As used herein, the term “cross-circulation circuit” refers to a path that blood, a man-made perfusate, or the like, flows through between an extracorporeal organ and a bioreactor to supply oxygen and nutrients to organs or tissue. Examples of cross-circulation circuits include veno-venous (VV) cross-circulation circuits and veno arterial venous (V-AV) cross-circulation circuits.

As used herein, the term “V-AV cross-circulation circuit” refers to a cross-circulation circuit that circulates blood, or another perfusate, between a vein and an artery of a host organism and between the host organism and an extracorporeal organ (optionally through an oxygenator) and back to the host organism to maintain physiologic stability of both the host organism and the extracorporeal organ. Other devices (heaters, sensors, pumps, etc.) may also be added to one or more parts of the V-AV cross-circulation circuit.

As used herein, the term “VV cross circulation circuit” refers to a cross-circulation circuit that circulates blood, or another perfusate, from a vein of a host organism (through an oxygenator) through an extracorporeal organ to another at least one vein of the host organism. Other devices (heaters, sensors, pumps, etc.) may also be added to one or more parts of the V-AV cross-circulation circuit.

As used herein, the term “normothermic” refers to an environmental temperature that does not cause increased or decreased activity of cells of a body. For a human body the peak normothermic temperature range is between approximately 36degrees Celsius and 38 degrees Celsius.

As used herein, the term “physiologic stability” refers to a dynamic range of physiological parameters that characterize normal function of an organism and/or one or more organs that make up the organism, that are not suffering from disease or injury. Physiological parameters can include, but are not limited to, oxygen saturation, pressure, temperature, and pH level. Physiologic stability also refers to maintaining a non-immune compromised status of a bioreactor or a host organism and an extracorporeal organ when they are xenogeneic or allogeneic to one another. For example, physiologic stability can be maintained with a semipermeable membrane substantially blocking immune compromising agents of the host organism in the blood, or other perfusate, from passing into the extracorporeal organ via the cross-circulation circuit, and vice versa.

As used herein, the term “immune compromised” refers to the state of being immunocompromised (e.g., having a reduced ability to fight infections and diseases) which can lead to physiological instability.

As used herein, the term “semipermeable membrane” refers to a type of biological or synthetic barrier that allows certain molecules, ions, or compounds to pass through, while preventing passage of other molecules, ions, compounds, or non- immune cells based on size. A semipermeable membrane may be adjustable so that the certain molecules, ions, or compounds allowed to pass or not allowed to pass through can be changed depending on the use of the system (e.g., organ resuscitation or experimenting with targeted therapeutics) and/or the type of organ being supported by the system.

As used herein, the term “bioreactor” refers to a device or host organism that can act as the support system for an extracorporeal organ. As an example, the bioreactor can include an allogeneic host organism, a xenogeneic host organism, a machine, or the like.

As used herein, the term “host organism” refers to any organism with a circulatory system with oxygen-carrying capacity, including, but not limited to, a human being, a pig, a rat, a mouse, a dog, a car, a goat, a sheep, a horse, a monkey, an ape, a rabbit, a cow, etc. that acts as the support system for an extracorporeal organ. For example, a host organism can be a different species than the extracorporeal organ it is supporting.

As used herein, the term “extracorporeal organ” refers to an organ situated outside the body of an organism (e.g., an organ provided by an organ donor, a lab grown organ, or an organ detached (voluntarily or involuntarily) from the host organism). An extracorporeal organ can include, but is not limited to, an internal organ (i.e., heart, liver, lungs, kidney, pancreas, small intestine, gut, etc.), an external organ (i.e., skin), tissue, a bioengineered graft, or a limb (i.e., arm, leg, hand, foot, etc.).

As used herein “extracorporeal” refers to something situated or occurring outside of the body of an organism.

As used herein the term “allogeneic” refers to tissues or cells that are from the same species but are genetically dissimilar from each other and therefore immunologically incompatible. For example, an extracorporeal organ from one donor of a species can be allogeneic to at least a part (e.g., blood, cells, tissue, etc.) of a host organism of the same species.

As used herein the term “xenogeneic” refers to tissues or cells that belong to individuals of different species and are therefore immunologically incompatible. For example, a swine host organism is xenogeneic to a human extracorporeal organ.

### II. Overview

Traditional transplant storage efforts, such as cold storage, are inefficient and cause significant bottlenecks in effective transplant procedures, causing the loss of a significant number of transplantable organs. Cross-circulation circuits, which use a live host organism (or other bioreactor) to maintain an extracorporeal organ's viability, improve transplant storage efforts by improving the length of time an extracorporeal organ can be kept viable. However, the host organism in a cross-circulation circuit may be xenogeneic or allogeneic to the extracorporeal organ, such that the immune system of the extracorporeal organ and the host organism are incompatible. Current cross circulations systems lack an ability to keep the host organism and the extracorporeal organ immunologically separated. Immunological interactions between the extracorporeal organ and the bioreactor can induce injury in the extracorporeal organ being salvaged or render the extracorporeal organ incapable of successful transplant. A barrier to reduce, or stop, the flow of immune compromising compounds from each of the host organism and the extracorporeal organism would reduce immunologic injuries and improve viability maintenance of the extracorporeal organ.

The present disclosure describes an immune reduced cross-circulation circuit that offers immune privilege between the extracorporeal organ being salvaged and the bioreactor that supports the extracorporeal organ in a homeostatic biosystem, where the extracorporeal organ stays in a condition of optimal functioning through maintenance of a steady state of internal, physical, and chemical conditions. The bioreactor that supports an extracorporeal organ is often a host organism that is a different species than the extracorporeal organ. For example, a bioreactor can be a pig (swine) host used to support a human extracorporeal organ. Immune effector cells, antibodies and other inflammatory molecules from a host organism (or other non-human host) can interact with the extracorporeal organ and induce injury.

The immune-reduced cross-circulation circuit improves extracorporeal organ viability for research and transplant purposes by preserving separation of the immune responses of the bioreactor (e.g., swine host) and the extracorporeal organ, while ensuring the extracorporeal organ and the bioreactor remain in homeostasis. Additionally, the cross-circulation circuit can permit more careful monitoring, functional testing, assessment, and therapy of the harvested organ. This would in turn allow earlier detection and potential repair of defects in the harvested organ, further reducing the likelihood of post-transplant organ failure. The ability to perform and assess simple repairs on the organ would also allow many organs with minor defects to be saved, whereas current transplantation techniques often require such organs to be discarded.

### III. Systems

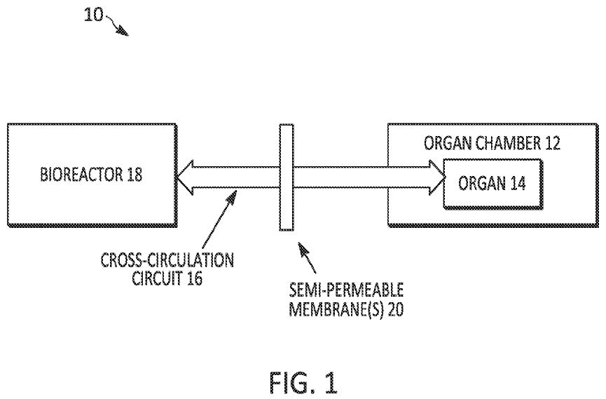

An aspect of the present disclosure can include a perfusion system 10 (FIG. 1) that employs an immune-reduced cross-circulation circuit 16 to pump a perfusate between an extracorporeal organ 14 and a bioreactor 18. As used herein, the extracorporeal organ 14 can be at least one of a liver, a lung, a kidney, a heart, a limb, skin, or a tissue substrate that can be held in organ chamber 12. As used herein the bioreactor 18 can be a host organism, such as a human being, a pig, a rat, a mouse, a dog, etc. The host organism can be allogeneic or xenogeneic to the extracorporeal organ 14, for example, the host organism can be a swine host and the extracorporeal organ can be human in origin. Due to immunological incompatibility the immune responses, which can include an innate immune response and an adaptive immune response, an immunological barrier is required to maintain the viability of the extracorporeal organ 14 and the bioreactor 18 (e.g., host organism) long term (e.g., 6 hours, 12 hours, 24 hours, 48 hours, a week, or longer). As used herein, the perfusate can be at least one of blood, a non-blood oxygen carrier, an acellular solution, and a crystalloid solution.

The perfusion system 10 can employ the immune-reduced cross-circulation circuit 16 to circulate a perfusate between a bioreactor 18 and an extracorporeal organ 14 to maintain the physiologic stability of at least the extracorporeal organ 14 by establishing an immunologic barrier (semi-permeable membrane(s) 20) to maintain separation between the immune responses of the bioreactor 18 and the immune responses of the extracorporeal organ 14. The perfusion system 10 maintains the quality and function of the extracorporeal organ 14 and the bioreactor 18 through the utilization of the immunologic barrier. Additionally, the system 10 can provide support for the extracorporeal organ 14 and/or the bioreactor 18 for an extended duration compared to traditional cold storage techniques.

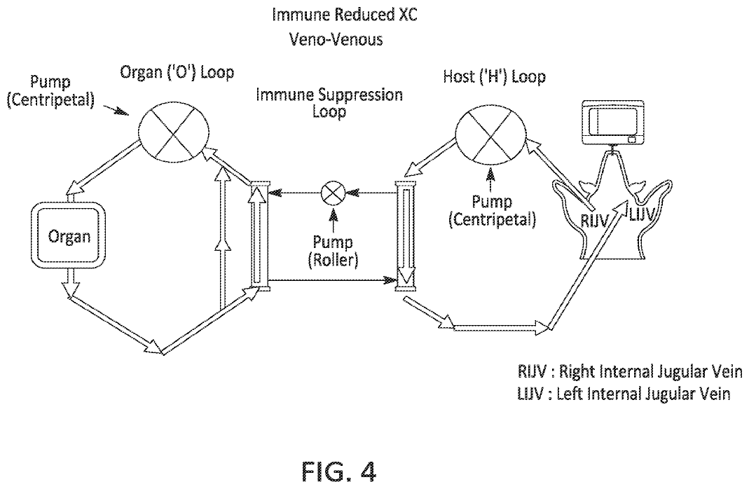

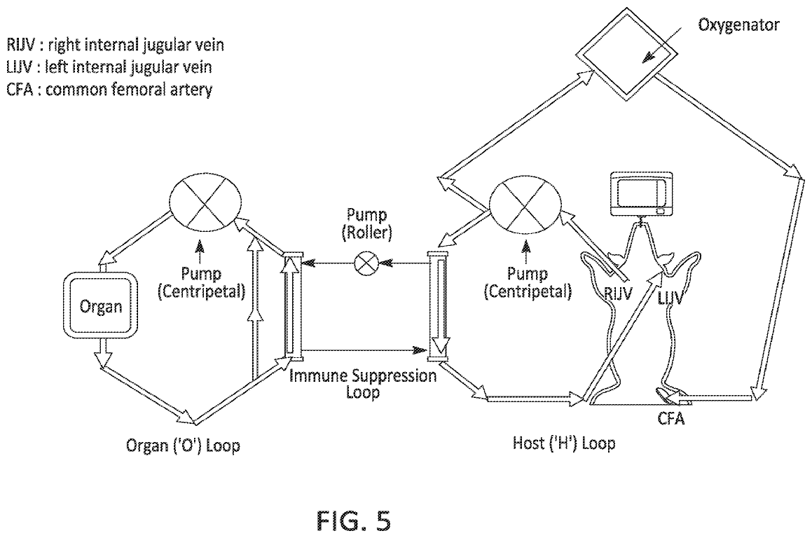

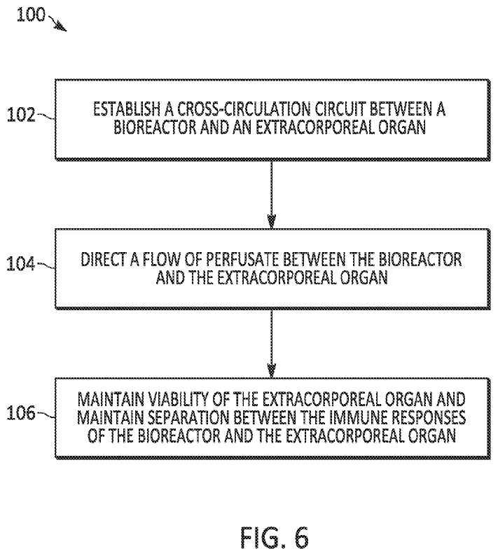

The immune-reduced cross-circulation circuit 16 is configured to connect the extracorporeal organ 14 and a bioreactor 18 and comprises at least one semipermeable membrane 20. The cross-circulation circuit 16 directs the flow of perfusate between the extracorporeal organ 14 and the bioreactor 18 and through the at least one semipermeable membrane (semipermeable membrane(s) 20). The immune-reduced cross-circulation circuit 16 can also include at least one pump to facilitate directing the flow of perfusate therethrough. The immune-reduced cross-circulation circuit 16 can maintain the extracorporeal organ 14 by perfusing the perfusate through the extracorporeal organ 14 and back to the bioreactor 18 (e.g., in a VV configuration, shown in FIG. 4, in a VAV configuration, shown in FIG. 5, or the like) while maintaining physiologic stability of the extracorporeal organ 14 and the bioreactor 18.

The perfusion system 10 can also employ one or more of a heater, a plurality of sensors, and a monitoring device (not shown). The heater, the plurality of sensors, and the monitoring device can all be utilized to help maintain the physiological stability of the extracorporeal organ 14 and the bioreactor 18 when the system 10 is in use.

One or more semipermeable membranes (semipermeable membrane(s) 20) of the cross-circulation circuit 16 can substantially prevent immune compromising compounds from flowing through from one side of the semipermeable membrane 20 to the other, while allowing non-immune compromising compounds through. The at least one semipermeable membrane (semipermeable membrane(s) 20) is configured to establish an immunologic barrier to maintain separation between immune responses of the bioreactor 18 and immune responses of the extracorporeal organ 14 and to maintain physiologic stability of the bioreactor 18 and the extracorporeal organ 14. Immune compromising compounds can include, but are not limited to, inflammatory molecules, antibodies, and immune effector cells. Non-immune compromising compounds can include, but are not limited to, electrolytes, hormones, substrates (e.g., exosomes, mRNA, etc.), and small proteins. The at least one semipermeable membrane 20 can include a plurality of pores configured to permit non-immune compromising compounds to pass through the entire cross-circulation circuit 16 based on sizes of the plurality of pores. The at least one semi-permeable membrane can be adjustable or modifiable based on the type of extracorporeal organ 14 being supported, any pharmacologic and/or immunologic modifications to the cross-circulation circuit 16, and/or to test experimental conditions in the fields of immunology, pharmacology, oncology, or the like.

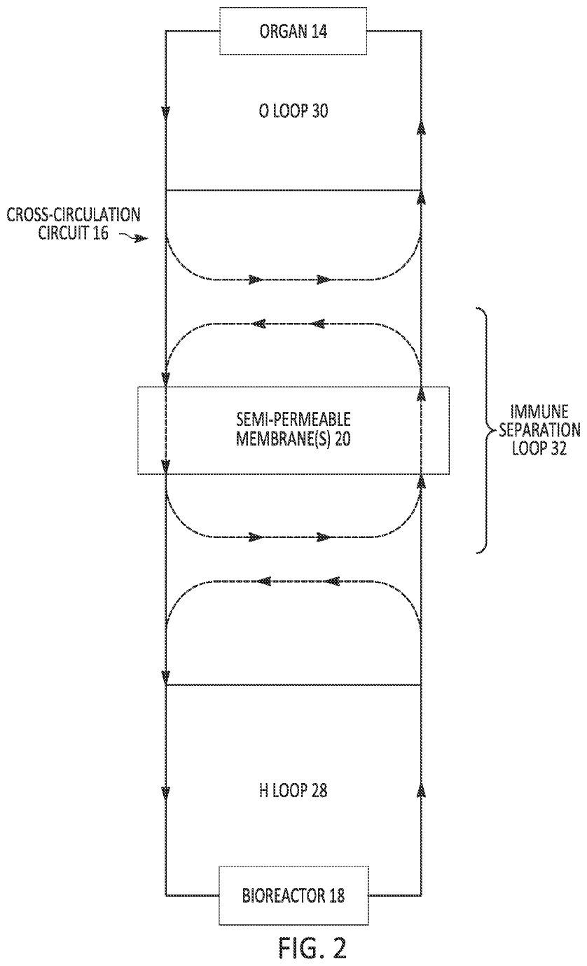

FIG. 2 shows an example cross-circulation circuit 16 that includes at least three separate perfusion loops at least partially in fluid communication with each other. The at least three separate perfusion loops can include an H loop 28, an O loop 30, and an immune separation loop 32. The H loop 28 can include the bioreactor 18, the O loop 30 can include the extracorporeal organ 14, and the immune separation loop 32 can include the at least one semipermeable membrane 20. The immune separation loop 32 can be positioned between the H loop 28 and the O loop 30 and can maintain immune response separation between the H loop and the O loop. The H loop 28, the O loop 30, and the immune separation loop 32 can interface via the at least one semipermeable membrane 20 to substantially keep immune compromising compounds in the loop they originated in. For example, the at least one semipermeable membrane 20 can keep immune compromising compounds generated by the bioreactor 18 (e.g., swine host) within the H loop 28 and immune compromising compounds generated by the extracorporeal organ 14 within the O loop 30. The cross-circulation circuit 16 can include at least one pump (not shown) in one or more of the H loop 28, the O loop 30, and the immune separation loop 32 to direct the flow of at least one perfusate therethrough.

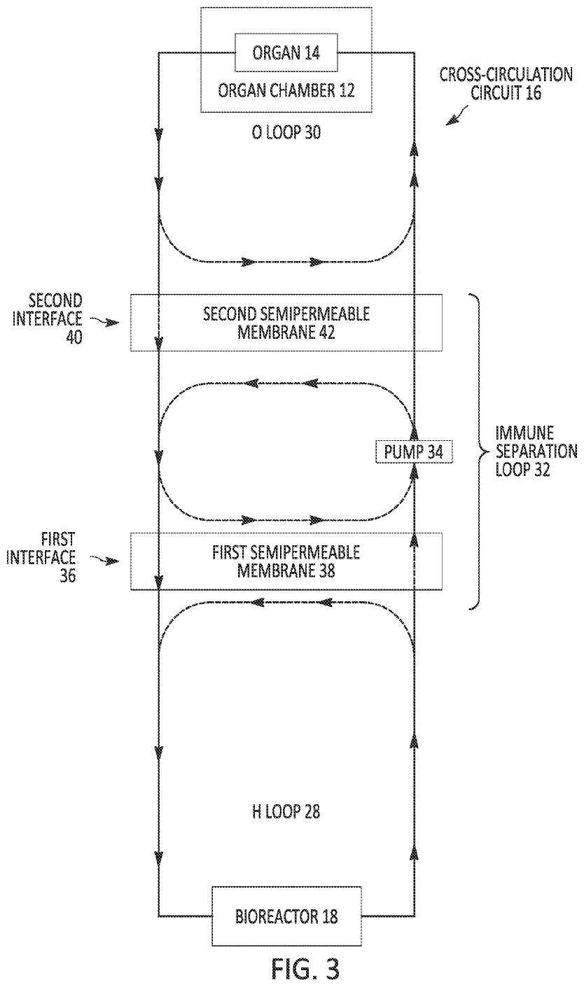

In another aspect, the cross-circulation circuit 16 that can maintain separation between immune responses of an extracorporeal organ 14 held in an organ chamber 12 and being supported by a bioreactor 18 is shown in FIG. 3. The cross-circulation circuit 16 can include an H loop 28, an O loop 30, an immune separation loop 32, and at least one pump 34. The H loop 28 can include the bioreactor 18, which can be allogeneic or xenogeneic to the extracorporeal organ 14. The O loop 30 can include the extracorporeal organ 14, which can be housed in the organ chamber 12. The immune separation loop 32 can include a first interface 36, with the H loop 28, that includes a first semipermeable membrane 38 and a second interface 40, with the O loop 30, that includes a second semipermeable membrane 42. The first semipermeable membrane 38 and the second semipermeable membrane 42 can maintain separation between the immune responses of the H loop 28 and the O loop 30.

The first membrane 38 and the second membrane 42 can be configured to substantially prevent immune compromising components from flowing through the first interface 36 and/or the second interface 40. The immune compromising components can be, for example, inflammatory molecules, antibodies, and immune effector cells. The first semipermeable membrane 38 and the second semipermeable membrane 42 each include a plurality of pores configured to permit non-immune compromising compounds in the perfusate to pass through based on the sizes of the plurality of pores. The non-immune compromising compounds can be, for example, at least one of electrolytes, hormones, substrates, and small proteins. For example, if the bioreactor 18 is a host organism of a different species than the extracorporeal organ 14, then the immune separation loop 32 can provide an immunologic barrier between the host organism and the extracorporeal organ that substantially prevents xeno-immune injury of the extracorporeal organ.

The at least one pump 34 can be configured to direct flow of one or more perfusate through at least one of the H loop 28, the O loop 30, and the immune separation loop 32. The one or more perfusate can be at least one of blood, a non-blood oxygen carrier, an acellular solution, and a crystalloid solution flows through at least one of the H loop 28, the O loop 30, and the immune separation loop 32. The H loop 28, the O loop 30, and the immune separation loop 32 can each have a different perfusate flowing therethrough. For example, the H loop 28 can have host blood from the bioreactor 18 perfused therethrough if the bioreactor is a host organism (for example, if the host organism is a swine, then the blood in the H loop can be pig's blood), the O loop 30 can have human blood (assuming the extracorporeal organ 14 is a human organ) or an acellular solution perfused therethrough, and the immune separation loop 32 can have a crystalloid solution flowing therethrough.

The perfusion system 10 can include cross-circulation circuits such as, for example, a Veno-Venous (VV) cross-circulation circuit (shown in FIG. 4) or a Veno-Arterial Venous VAV cross-circulation circuit (shown in FIG. 5). These examples are non-limiting and only provided to show two representative systems, not all illustrated components may be needed in every aspect and other components or connection points not illustrated may exist in other aspects. FIGS. 4 and 5 each show a representation of perfusion system 10 where the extracorporeal organ in the O loop is attached to a bioreactor that is a swine host in the H loop via an immune separation loop having two semipermeable membranes. A first semipermeable membrane interfaces between the H loop and the immune separation loop and a second semipermeable membrane interfaces between the O loop and the immune separation loop. The semipermeable membranes permit the non-immune compromising compounds in the perfusate through, while preventing the immune compromising compounds from crossing between loops, the perfusate may or may not be allowed through the semipermeable membranes depending on the application and the types of perfusate(s) utilized in each of the O loop, the H loop, and the immune separation loop. The perfusate can be, for example, one or more of blood, a non-blood oxygen barrier, an acellular solution, a crystalloid solution, or the like. The different loops may use the same perfusate or a different perfusate.

The immune responses, innate and adaptive, of the organ and the swine host are separated while the compounds needed to maintain physiological stability of the extracorporeal organ and the swine host are circulated through the system. As shown at least one centripetal pump is positioned in the O loop and the H loop and a roller pump is positioned in the immune separation loop. The pumps direct the flow of perfusate through the system and can be any kind of pumps known in the field. In some aspects, a fewer or greater number of pumps can be in each loop of the system. The cross-circulation circuits can be attached to the extracorporeal organ and the swine host through at least one vein and at least one artery each (for example via cannulation).

In a VV cross-circulation circuit the viability and physiological stability of an extracorporeal organ is maintained by pumping blood out of a body of a host organism through one vein (e.g., an internal jugular vein) and through an extracorporeal organ (e.g., through at least one vein and at least one artery of the extracorporeal organ) before the blood is return to the host organism through the same or another vein. In a VAV cross-circulation circuit the viability and physiological stability of an extracorporeal organ is maintained by pumping blood out of the body of a host organism through one vein (e.g., an internal jugular vein) where part of the blood is oxygenated before being returned back into the body of the host organism through an artery of the host organism and another part of the blood is pumped through the extracorporeal organ and back into the host organism through the same or another vein. For example, when the organ is a liver, blood can be pumped out of an internal jugular vein of the host and oxygenated before part of the oxygenated blood is pumped to a common femoral artery of the host and the other part of the oxygenated blood is pumped into a hepatic artery and portal vein of the liver to perfuse the liver before the perfused blood is returned to a contralateral internal jugular vein of the host.

In the VV cross-circulation circuit example of FIG. 4 the cross-circulation circuit maintains the extracorporeal organ by perfusing perfusate in the H loop from a first vein (shown as the right internal jugular vein but can be any appropriate vein) to a first semipermeable membrane at the interface with the immune separation loop (facilitated via a pump). The semipermeable membrane substantially prevents immune compromising compounds from the swine host from entering the immune separation loop. The perfusate with at least reduced immune compromising compounds is then directed (via a pump) through a first part of the immune separation loop and through the second semipermeable membrane to the O loop. The second semipermeable membrane may prevent any immune compromising compounds that made it into the immune separation loop from entering the O loop. The perfusate is then directed (via a pump) through the extracorporeal organ. After leaving the extracorporeal organ a part of the perfusate is then cycled back to the extracorporeal organ without leaving the O loop and another part of the perfusate is directed back through the second semipermeable membrane, which substantially prevents immune compromising compounds from the extracorporeal organ from entering the immune separation loop. The perfusate is then directed through a second part of the immune separation look and back through the first semipermeable membrane (which may prevent any immune compromising compounds of the organ that slipped through the second semipermeable membrane from entering the H loop) and into another and/or contralateral vein of the swine host (shown as the left internal jugular vein but can be any acceptable vein or artery). The cycle can then repeat as long as the viability of the extracorporeal organ needs to be maintained.

In the VAV cross-circulation circuit example of FIG. 5 the cross-circulation circuit maintains the extracorporeal organ by perfusing perfusates through the O loop, the H loop, and the immune separation loop as described with respect to the example in FIG. 3. The VAV system of FIG. 5 includes another arm of the H loop where perfusate from the host swine is pumped from the first vein (shown as right internal jugular vein) and through an oxygenator (and optionally a heater, not shown) and back into the swine host via an artery (shown as the common femoral artery but can be any appropriate artery. This extra arm of the H loop does not interact with the immune separation loop but can help maintain the physiologic stability of the host swine (or any living bioreactor).

### IV. Methods

Another aspect of the present disclosure can include method 100 for maintaining physiologic stability of a host organism and an extracorporeal organ. The method 100 can be executed using the perfusion system 10 shown in FIG. 1 and exemplified in FIGS. 2-4. For purposes of simplicity, the method 100 is shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the method 100, nor is method 100 limited to the illustrated aspects.

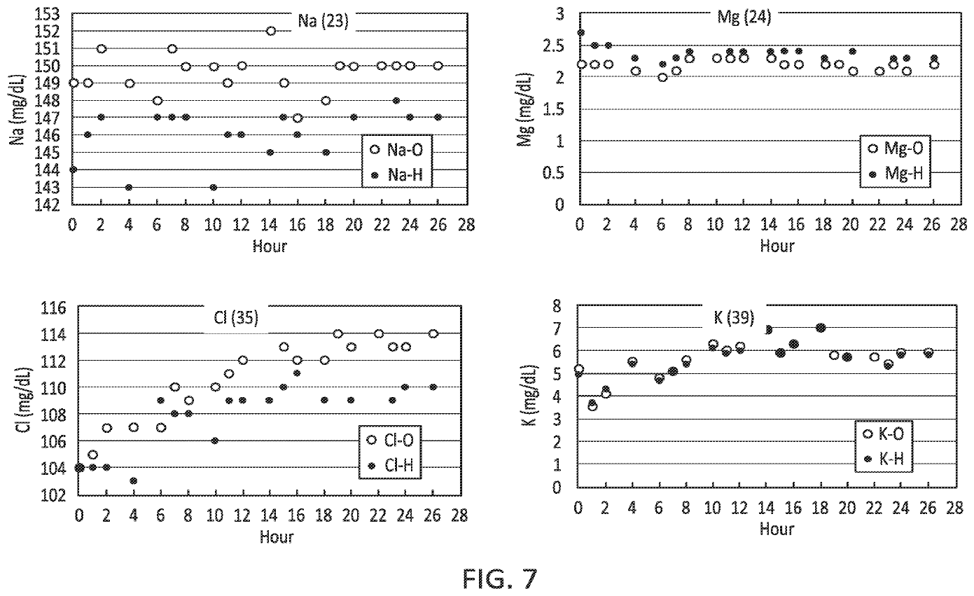

Referring now to FIG. 7, illustrated is a method 100 for supporting the viability of an extracorporeal organ with a bioreactor using an immune interfacing reducing cross-circulation circuit. At 102, a cross-circulation circuit can be established between a bioreactor and an extracorporeal organ in an organ chamber. The cross-circulation circuit can include an H loop, an O loop, an immune separation loop, and at least one pump. The H loop can include the bioreactor, such as, a host organism. The O loop can include the extracorporeal organ, which can be held in an organ chamber. The extracorporeal organ can be, for example, a lung, a live, a kidney, a heart, a tissue, or the like. The immune separation loop can include a first interface, with the H loop, and a second interface, with the O loop. The first interface can include a first semipermeable membrane and the second interface can include a second semipermeable membrane.

At 104, a flow of perfusate can be configured to direct the flow of perfusate between the bioreactor in the H loop and the extracorporeal organ in the O loop through the immune separation loop. The at least one pump can direct the flow of at least one perfusate through at least one of the H loop, the O loop, and the immune separation loop. The one or more perfusate can enter and/or exit the extracorporeal organ and the bioreactor (e.g., a host organism) through cannulations of at least one vein and/or at least one artery in each of the extracorporeal organ and the bioreactor.

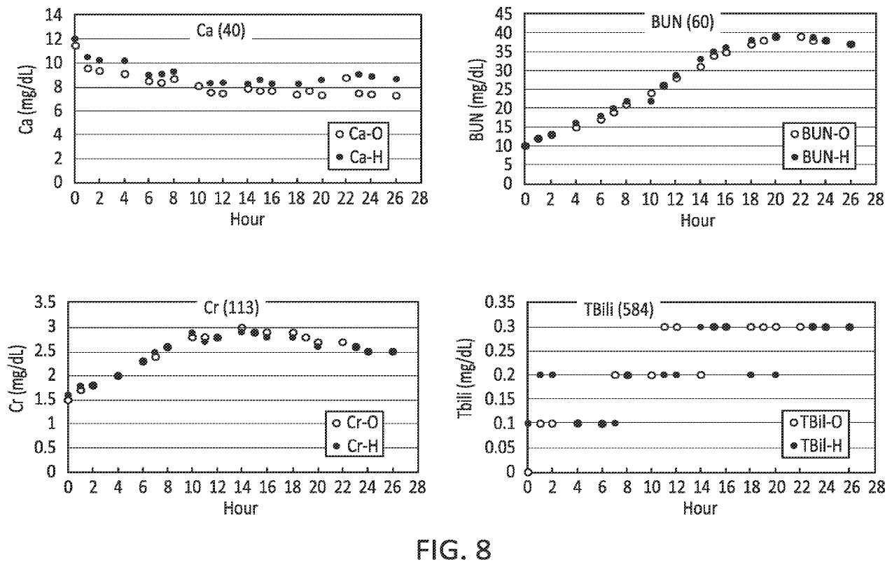

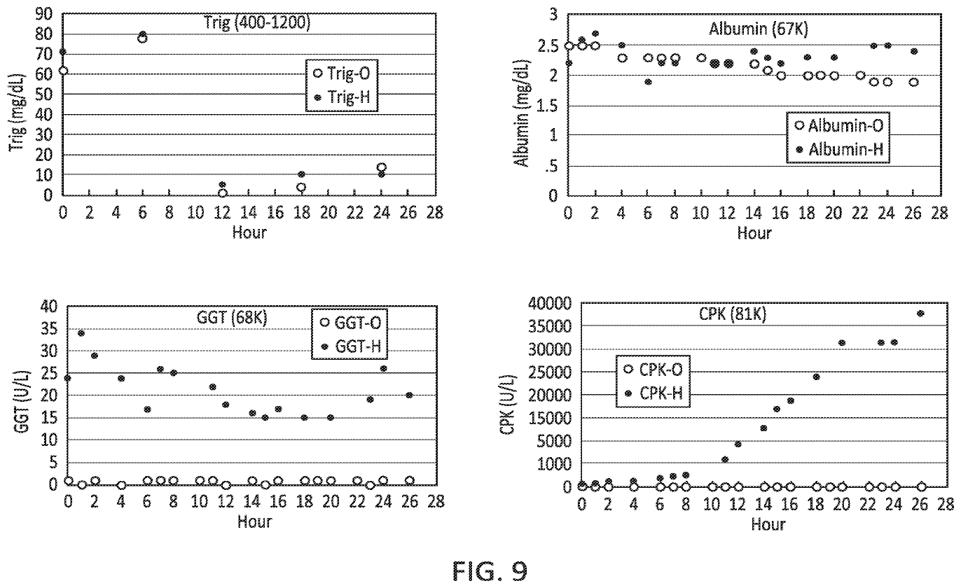

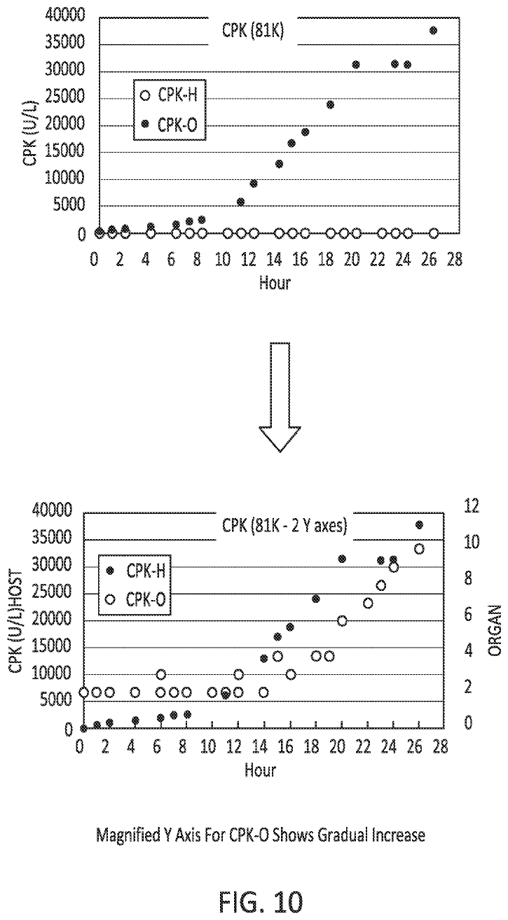

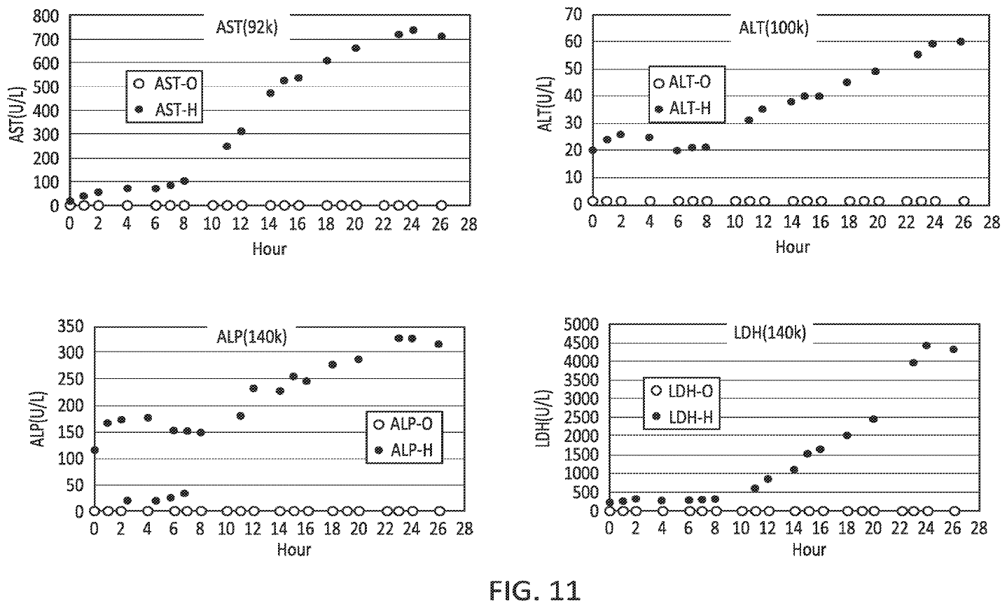

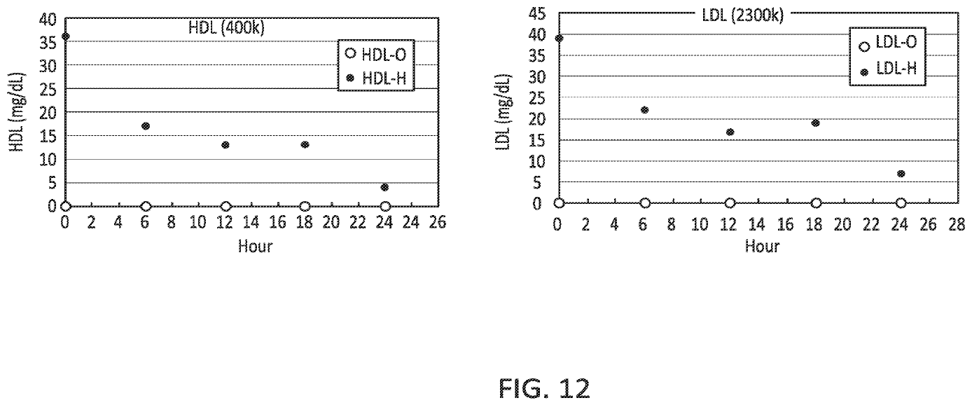

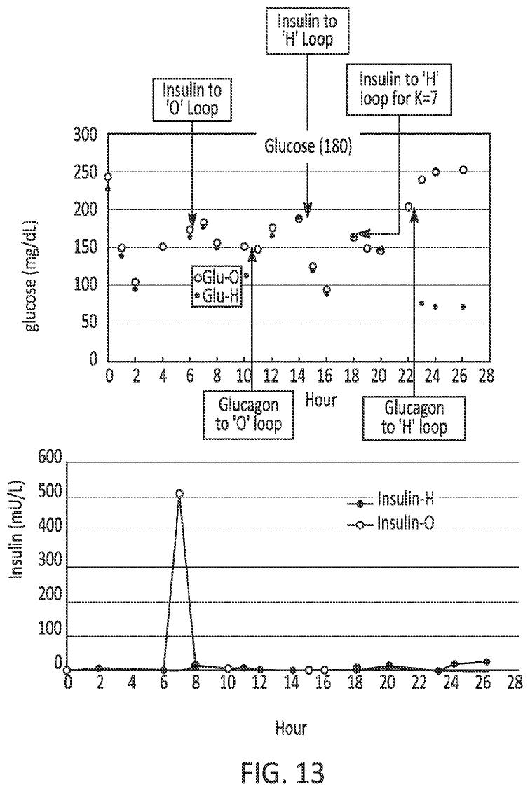

At 106, the viability of the extracorporeal organ can be maintained using the first semipermeable membrane and the second semipermeable membrane of the O loop. The first semipermeable membrane and the second semipermeable membrane are configured to maintain separation between the immune responses of the bioreactor and the extracorporeal organ within the H loop and the O loop, respectively. The first membrane and the second membrane can be configured to substantially prevent immune compromising components from flowing through. Immune compromising compounds can include, but are not limited to, inflammatory molecules, antibodies, and immune effector cells. The first semipermeable membrane and the second semipermeable membrane can each include a plurality of pores configured to permit non-immune compromising compounds to pass through based on sizes of the plurality of pores. The non-immune compromising compounds comprise electrolytes, hormones, substrates, and small proteins. Examples compounds (e.g., Na, Ca, Cl, K, Mg, glucose, HDL, LDL, etc.) that can and cannot pass through the plurality of pores of the first and second semipermeable membranes are shown in the graphical representations of FIGS. 7-13. The compounds are listed with their molecular weights and the graphical representations show the concentrations of each compound in each of the O loop and the H loop over a 28-hour time course, with changes in concentrations corresponding, at least partially, with if a compound could pass through the semipermeable barrier. The porosity of the first and second semipermeable membranes can be adjusted, each can be adjusted separately, so that specifically targeted molecules and/or compounds can be allowed through the membranes depending on the usage of the system (e.g., organ resuscitation or experimenting with targeted therapies).

From the above description, those skilled in the art will perceive improvements, changes and modifications. Such improvements, changes and modifications are within the skill of one in the art and are intended to be covered by the appended claims.

The following is claimed:

1. A system comprising:
an organ chamber configured to hold an extracorporeal organ; and
a cross-circulation circuit configured to connect the extracorporeal organ and a bioreactor and direct the flow of perfusate therebetween,
wherein the cross-circulation circuit comprises at least one semipermeable membrane configured to establish an immunologic barrier to maintain separation between immune responses of the bioreactor and immune responses of the extracorporeal organ and to maintain physiologic stability of the bioreactor and the extracorporeal organ.

2. The system of claim 1, wherein the bioreactor is a host organism.

3. The system of 2, wherein the host organism is allogeneic or xenogeneic to the extracorporeal organ.

4. The system of claim 1, wherein the cross-circulation circuit comprises an H loop comprising the bioreactor, an O loop comprising the extracorporeal organ, and an immune separation loop maintaining immune response separation between the H loop and the O loop, wherein the H loop, the O loop, and the immune separation loop interface via the at least one semipermeable membrane.

5. The system of claim 1, wherein the at least one semipermeable membrane prevents immune compromising compounds from flowing therethrough.

6. The system of 5, wherein the immune compromising compounds comprise inflammatory molecules, antibodies, and immune effector cells.

7. The system of 5 wherein the at least one semipermeable membrane comprises a plurality of pores configured to permit non-immune compromising compounds to pass through the cross-circulation circuit based on sizes of the plurality of pores.

8. The system of 5, wherein the non-immune compromising compounds comprise electrolytes, hormones, substrates, and small proteins.

9. The system of 1, wherein the extracorporeal organ is at least one of a liver, a lung, a kidney, a heart, a limb, skin, or a tissue substrate.

10. The system of 1, wherein the immune response is an innate immune response or an adaptive immune response.

11. A cross-circulation circuit comprising:
an H loop comprising a bioreactor;
an O loop comprising an extracorporeal organ, wherein the extracorporeal organ is housed in an organ chamber; and
an immune separation loop comprising:
a first interface with the H loop comprising a first semipermeable membrane,
a second interface with the O loop comprising a second semipermeable membrane,
wherein the first semipermeable membrane and the second semipermeable membrane are configured to maintain separation between immune responses of the H loop and the O loop, and
at least one pump configured to direct flow through at least one of the H loop, the O loop, and the immune separation loop.

12. The cross-circulation circuit of 11, wherein at least one of blood, a non-blood oxygen carrier, an acellular solution, and a crystalloid solution flows through at least one of the H loop, the O loop, and the immune separation loop.

13. The cross-circulation circuit of 11, wherein the H loop, the O loop, and the immune separation loop each comprise a different perfusate.

14. The cross-circulation circuit of 11, wherein the first membrane and the second membrane are configured to prevent immune compromising components from flowing through the first interface and/or the second interface.

15. The cross-circulation circuit of 14, wherein the immune compromising components comprise inflammatory molecules, antibodies, and immune effector cells.

16. The system of 11, wherein the first semipermeable membrane and the second semipermeable membrane each comprise a plurality of pores configured to permit non-immune comprising compounds in the perfusate to pass through based on sizes of the plurality of pores.

17. The system of 16, wherein the non-immune compromising compounds comprise electrolytes, hormones, substrates, and small proteins.

18. The cross-circulation circuit of 11, wherein the bioreactor comprises a host organism of a different species than the extracorporeal organ and the immune separation loop provides an immunologic barrier between the host organism and the extracorporeal organ to prevent xeno-immune injury of the extracorporeal organ.

19. A method comprising:
establishing a cross-circulation circuit between a bioreactor and an extracorporeal organ in an organ chamber, wherein the cross-circulation circuit comprises:
an H loop comprising the bioreactor,
an O loop comprising the extracorporeal organ,
an immune separation loop, and
at least one pump configured to direct flow through at least one of the H loop, the O loop, and the immune separation loop;
directing a flow of perfusate between the bioreactor in the H loop and the extracorporeal organ in the O loop through the immune separation loop, wherein the immune separation loop comprises:
a first interface with the H loop comprising a first semipermeable membrane, and
a second interface with the O loop comprising a second semipermeable membrane; and
maintaining viability of the extracorporeal organ using the first semipermeable membrane and the second semipermeable membrane, wherein the first semipermeable membrane and the second semipermeable membrane are configured to maintain separation between immune responses within the H loop and the O loop.

20. The method of claim 19, wherein the perfusate enters and exits the extracorporeal organ and the bioreactor through cannulations of at least one vein and/or at least one artery in each of the extracorporeal organ and the bioreactor.

21. The method of 19, wherein the first membrane and the second membrane are configured to prevent immune compromising components from flowing through.

22. The method of 21, wherein the immune compromising compounds comprise inflammatory molecules, antibodies, and immune effector cells.

23. The method of 19, wherein the first semipermeable membrane and the second semipermeable membrane comprises a plurality of pores configured to permit non-immune compromising compounds to pass through based on sizes of the plurality of pores.

24. The method of 23, wherein the non-immune compromising compounds comprise electrolytes, hormones, substrates, and small proteins.
